(19) United States
(12) Patent Application Publication
(10) Pub. No.: US 2022/0300658 A1
(43) Pub. Date: Sep. 22, 2022

(54) NON-TRANSITORY COMPUTER READABLE MEDIUM, INFORMATION PROCESSING APPARATUS, AND METHOD FOR INFORMATION PROCESSING

(71) Applicant: FUJIFILM BUSINESS INNOVATION CORP., Tokyo (JP)

(72) Inventors: Ryo KUKIMIYA, Kanagawa (JP); Masamichi TAKAHASHI, Kanagawa (JP); Koki UWATOKO, Kanagawa (JP); Ikuro FUJINO, Kanagawa (JP); Ryo HASEGAWA, Kanagawa (JP)

(73) Assignee: FUJIFILM BUSINESS INNOVATION CORP., Tokyo (JP)

(21) Appl. No.: 17/387,597

(22) Filed: Jul. 28, 2021

(30) Foreign Application Priority Data
Mar. 22, 2021 (JP) 2021-047854

(51) Int. Cl. G06F 21/64; H04L 9/32; G06F 16/13; G06F 16/23; G06F 21/60

(52) U.S. Cl. CPC G06F 21/64; H04L 9/3239; G06F 16/137; G06F 16/2379; G06F 21/602

(57) ABSTRACT

A non-transitory computer readable medium stores a program causing a computer to execute a process, the process including preparing a target file for manipulation, the target file being a file to be manipulated, acquiring information regarding a situation in which the target file is manipulated, creating history information and a hash value of the history information based on the information that was acquired, in a case where a predetermined event occurs, the history information indicating occurrence of the predetermined event, and associating the history information with the hash value and transmitting a transaction including the hash value to a blockchain network.

### CROSS-REFERENCE TO RELATED APPLICATIONS

This application is based on and claims priority under 35 USC 119 from Japanese Patent Application No. 2021-047854 filed Mar. 22, 2021.

### BACKGROUND

### (i) Technical Field

The present disclosure relates to a non-transitory computer readable medium, an information processing apparatus, and a method for information processing.

### (ii) Related Art

Various methods have been proposed and adopted to check or evaluate the security of an information processing system or to maintain a secure state of an information processing system.

Japanese Patent No. 6533924 discloses an information processing system that includes a video recording apparatus, which creates video recording data that contains video images obtained from a surveillance camera, and a determination apparatus, which determines whether video recording data has been altered. In this information processing system, the video recording apparatus transmits to a blockchain network a transaction containing alteration-prevention data, which includes a hash value of video recording data, and stores, in a property or the name of a file, identification information to identify a transaction registered in the blockchain. The property and the name of the file do not affect the hash value of video recording data. The determination apparatus identifies a transaction in the blockchain by using the identification information extracted from the property or the name of the file, the identification information being used to identify the transaction, acquires alteration-prevention data from the transaction that was identified, compares the hash value of the video recording data with the hash value contained in the alteration-prevention data, which is acquired from the transaction in the blockchain, and determines whether the video recording data has been altered.

### SUMMARY

When manipulation on an information processing system is monitored, a monitoring method such as capturing images by using a surveillance camera is not allowed in some cases to avoid acquisition of information other than the information regarding a monitoring target. Thus, a monitoring method that acquires only the information regarding manipulation to be monitored and that can guarantee the authenticity of the acquired information has been awaited.

Aspects of non-limiting embodiments of the present disclosure relate to providing a system that acquires only information regarding manipulation on an information processing system and that guarantees the authenticity of the acquired information. This system contrasts a method such as using images captured by a camera as monitoring information regarding manipulation on the information processing system.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a non-transitory computer readable medium storing a program causing a computer to execute a process, the process including:

preparing a target file for manipulation, the target file being a file to be manipulated;

acquiring information regarding a situation in which the target file is manipulated;

based on the information that was acquired, in a case where a predetermined event occurs, creating history information and a hash value of the history information, the history information indicating occurrence of the predetermined event; and

associating the history information with the hash value and transmitting a transaction including the hash value to a blockchain network.

### BRIEF DESCRIPTION OF THE DRAWINGS

An exemplary embodiment of the present disclosure will be described in detail based on the following figures, wherein:

FIG. 1 is an illustration depicting a configuration of an information processing system to which the present exemplary embodiment is applied;

FIG. 2 is a diagram depicting an example of a hardware configuration of a provider apparatus, a user apparatus, and a management server according to the present exemplary embodiment;

FIGS. 3A and 3B depict an example of history information created in response to receiving of content, FIG. 3A depicts an example of a structure of the history information, and FIG. 3B depicts descriptions of the events;

FIGS. 4A and 4B depict an example of history information created in response to manipulation to start document-file viewing, FIG. 4A depicts an example of a structure of the history information, and FIG. 4B depicts descriptions of the events;

FIGS. 5A, 5B, and 5C depict examples of history information based on events during document-file viewing, FIG. 5A depicts an example of a structure of history information that corresponds to regular viewing, FIG. 5B depicts an example of a structure of history information that corresponds to occurrence of an irregular situation during viewing, and FIG. 5C depicts descriptions of the events;

FIGS. 6A and 6B depict an example of history information created in response to termination of document-file viewing, FIG. 6A depicts an example of a structure of the history information, and FIG. 6B depicts a description of the event;

FIGS. 7A and 7B depict an example of history information created in response to discarding of content containing a document file, FIG. 7A depicts an example of a structure of the history information, and FIG. 7B depicts a description of the event;

FIG. 8 depicts how the provider apparatus provides content;

FIG. 9 depicts how the user apparatus receives content;

FIG. 10 depicts how the user apparatus creates history information based on receiving of content;

FIG. 11 depicts synchronization of transactions in a blockchain;

FIG. 12 depicts an operation performed by the user apparatus in response to manipulation to start document-file viewing;

FIG. 13 depicts an operation performed by the user apparatus in response to occurrence of a regular event during document-file viewing;

FIG. 14 depicts an operation performed by the user apparatus in response to occurrence of an irregular event during document-file viewing;

FIG. 15 depicts an operation performed by the user apparatus in response to manipulation to terminate document-file viewing;

FIG. 16 depicts an operation performed by the user apparatus in response to discarding of content;

FIG. 17 depicts an example of history information created by a series of operations performed during regular document-file viewing;

FIG. 18 depicts an example of history information created by a series of operations performed when an irregular event occurs during document-file viewing;

FIG. 19 is a flowchart depicting an operation performed by the user apparatus when content is received;

FIG. 20 is a flowchart depicting an operation performed by the user apparatus when viewing starts in a viewing cycle;

FIG. 21 is a flowchart depicting an operation performed by the user apparatus during viewing in a viewing cycle; and

FIG. 22 is a flowchart depicting an operation performed by the user apparatus when content is discarded.

### DETAILED DESCRIPTION

Hereinafter, an exemplary embodiment of the present disclosure will be described in detail with reference to the attached drawings. The present exemplary embodiment provides a system that monitors and can verify details of manipulation when a user manipulates a file provided by a provider. An information processing system according to the present exemplary embodiment includes a management system that manages monitoring information regarding manipulation of a target file, which is to be manipulated, and a blockchain system to guarantee the authenticity of the monitoring information managed by the management system. Overall Configuration

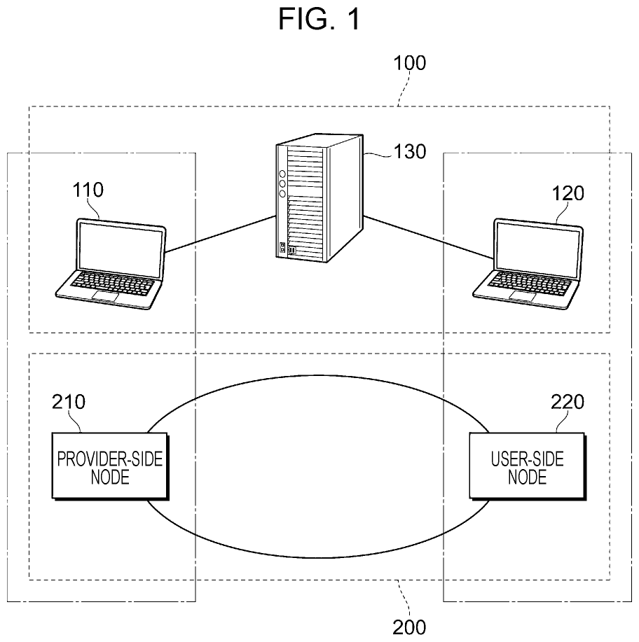

FIG. 1 is an illustration depicting a configuration of the information processing system, to which the present exemplary embodiment is applied. A management system 100 enables a provider to provide a user with a target file and manages monitoring information regarding manipulation of the target file by the user. The management system 100 includes a provider apparatus 110, a user apparatus 120, and a management server 130. A blockchain system 200 is used to guarantee the authenticity of the monitoring information managed by the management system 100. The blockchain system 200 includes a provider-side node 210, which is a node of the provider, and a user-side node 220, which is a node of the user.

The provider apparatus 110 is used by the provider, who provides a target file. For example, a computer is used as the provider apparatus 110. The provider apparatus 110 is connected to the management server 130 via a communication network. The provider apparatus 110 has a function of transmitting to the management server 130 a target file to be used by the user and a function of receiving management data managed by the management server 130. By using the provider apparatus 110, the provider can provide a target file and acquire and verify monitoring information managed by the management server 130 as management data.

The user apparatus 120 is used by the user, who manipulates a target file. For example, a computer is used as the user apparatus 120. The user apparatus 120 is connected to the management server 130 via the communication network. The user apparatus 120 has a function of receiving from the management server 130 a target file to be used by the user and a function of transmitting to the management server 130, as management data, monitoring information regarding manipulation of the target file. By using the user apparatus 120, the user can acquire a target file and manipulates the target file. In addition, the user apparatus 120 has a function of creating data used to guarantee the authenticity of monitoring information and a function of updating a transaction at the user-side node 220 in the blockchain system 200. A transaction is data managed by the blockchain system 200. In the present exemplary embodiment, the blockchain system 200 manages, as a transaction, data used to guarantee the authenticity of monitoring information.

The management server 130 manages monitoring information. For example, a computer is used as the management server 130. The management server 130 may be formed by using a cloud server constructed on a network. The management server 130 receives and retains a target file from the provider apparatus 110 and transmits a retained target file to the user apparatus 120 in accordance with a request from the user apparatus 120. The management server 130 also receives from the user apparatus 120 monitoring information created by execution of manipulation of a target file and manages the monitoring information. In addition, the management server 130 transmits to the provider apparatus 110 monitoring information, which is management data, in accordance with a request from the provider apparatus 110.

The provider-side node 210 and the user-side node 220 in the blockchain system 200 are nodes that share a transaction in the blockchain system 200. The provider-side node 210 is used by the provider, who uses the provider apparatus 110. The user-side node 220 is used by the user, who uses the user apparatus 120. The provider-side node 210 may be formed as a function of the provider apparatus 110 or formed by an apparatus such as another computer or a server on a network, which is accessible by the provider apparatus 110. The user-side node 220 may be formed as a function of the user apparatus 120 or formed by an apparatus such as another computer or a server on a network, which is accessible by the user apparatus 120.

The provider-side node 210 and the user-side node 220 can communicate with each other by using a point-to-point (P2P) technique and share transactions difficult to tamper with by reaching an agreement based on a predetermined consensus algorithm. If some participants in the blockchain try to tamper with a transaction, tampering fails unless the number of participants who try to tamper with the transaction exceeds a predetermined number. Thus, in the present exemplary embodiment, the blockchain system 200 manages, as a transaction, data that is used to guarantee the authenticity of monitoring information created by the user apparatus 120. In the following description, data used to guarantee the authenticity of monitoring information is referred to as guarantee data.

### Method of Target-File Provision and Functions Provided by Execution Program

In the present exemplary embodiment, a target file and an execution program to manipulate the target file are combined and provided as content that allows only the execution program to manipulate the target file. For example, if a target file is a document file, content formed by combining viewing software or editing software as an execution program with the document file as the target file is provided. Further, if a target file is a video file or an audio file, content formed by combining replay software as an execution program with the video file or the audio file as the target file is provided. In this way, since a target file is combined with an execution program to form content, no function except the function provided by the execution program is allowed to prepare the target file for manipulation.

An execution program enables the user apparatus 120 to perform a function of monitoring manipulation of a target file in addition to a function of manipulating the target file. Specifically, an execution program creates history information regarding events that occur in relation to manipulation of a target file. Examples of an event to be recorded in history information include acquisition of a target file, start and termination of manipulation of a target file, a predetermined event that may occur during manipulation of a target file, and discarding of a target file. History information indicating that manipulation is being performed in a normal manner may be created periodically while a target file is manipulated. Examples of history information include a time that an event occurred and information indicating a description of an event, which will be described in detail below. History information may include hash values of these kinds of information. Such history information is sent to the management server 130 as monitoring information regarding manipulation of a target file and managed by the management server 130.

Further, an execution program enables the user apparatus 120 to perform a function of checking whether the user apparatus 120 has a set-up necessary to acquire the history information described above. For example, when a camera or a sensor is used to detect an event that occurs while a target file is manipulated, an execution program provides the user apparatus 120, as a device set-up, with a function of checking whether a camera or a sensor is connected to the user apparatus 120 and whether the execution program provides control to enable the camera to capture image data or to enable the sensor to obtain detection data. In the following description, a device used to detect an event that occurs while a target file is manipulated is referred to as a monitoring device, and examples of a monitoring device include a camera and a sensor.

An execution program also enables the user apparatus 120 to perform a function of controlling the monitoring device described above and acquiring information regarding a situation in which a target file is manipulated. Further, an execution program enables the user apparatus 120 to perform a function of checking whether an environment suitable for manipulation of a target file is provided. For example, if the absence of a person except the user in the same room is designated as a requirement for manipulation of a target file, an execution program provides the user apparatus 120 with a function of using information obtained by a camera or a motion sensor to check, as an environment for manipulation, whether a person except the user is present in the room.

An execution program also creates guarantee data in accordance with created history information and enables the user apparatus 120 to provide a function of registering the guarantee data at the user-side node 220 as a transaction of the blockchain system 200. When a second or later event occurs for a single target file, the execution program creates guarantee data in accordance with history information regarding the second or later event that occurred and updates the corresponding transaction at the user-side node 220. The corresponding transaction is the transaction in which the guarantee data regarding the same target file is recorded. If a new transaction is registered or an existing transaction is updated at the user-side node 220, transactions are synchronized between the user-side node 220 and the provider-side node 210.

In addition, an execution program may enable the user apparatus 120 to perform a function of reporting occurrence of an irregular event or preventing an irregular event from occurring in accordance with the kind of detected irregularity in response to the detection of the occurrence of the irregular event, which will be described below. Further, an execution program may enable the user apparatus 120 to perform a function of reporting occurrence of an irregular event to the provider apparatus 110 or to the management server 130 in response to the detection of the occurrence of the irregular event.

As described in detail below, when acquiring content, the user apparatus 120 also creates history information and guarantee data based on the acquisition of the content, transmits the history information to the management server 130, and updates a transaction at the user-side node 220 by using the guarantee data. When discarding content, the user apparatus 120 also creates history information and guarantee data based on the discarding of the content, transmits the history information to the management server 130, and updates a transaction at the user-side node 220 by using the guarantee data. These operations performed when content is acquired or discarded may be performed not by an execution program contained in the content but by a function provided, for example, by a program installed on the user apparatus 120 in advance.

### Hardware Configuration

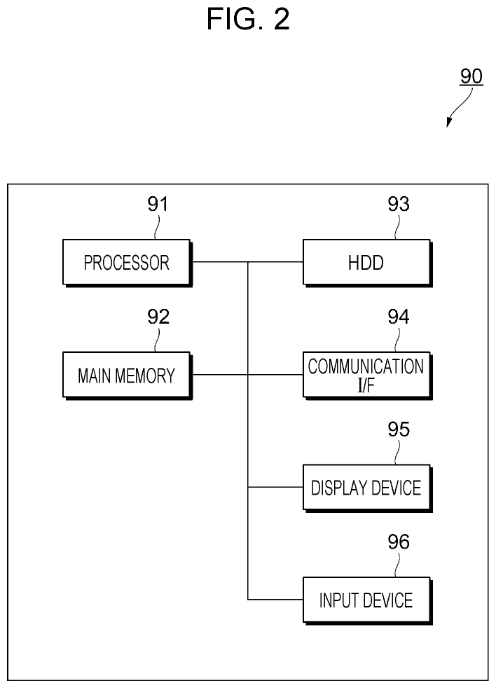

FIG. 2 is a diagram depicting an example of a hardware configuration of the provider apparatus 110, the user apparatus 120, and the management server 130 according to the present exemplary embodiment. Each apparatus is represented by a computer 90. As depicted in FIG. 2, the computer 90 includes a processor 91, a main memory 92, and a hard disk drive (HDD) 93. The processor 91 executes various kinds of software such as the operating system (OS) and applications and provides various functions for each apparatus. The main memory 92 is a storage region to store various kinds of software, data to be used for execution of the various kinds of software, and other kinds of data. The HDD 93 is a storage region to store data that is input to the various kinds of software, data that is output from the various kinds of software, and other kinds of data. The computer 90 also includes a communication interface (I/F) 94 for communicating with external apparatuses, a display device 95 such as a display, and an input device 96 including a keyboard and a mouse.

In a case where the provider apparatus 110 is formed by using the computer 90, which is depicted in FIG. 2, for example, the processor 91 executes a program to create content containing a target file and an execution program. For example, the processor 91 executes a program to control the communication I/F 94 and performs processing of transmitting the created content to the management server 130 and receiving management data from the management server 130. In addition, when the provider apparatus 110 is enabled to function as the provider-side node 210, the processor 91 executes a program to function as the provider-side node 210.

In a case where the user apparatus 120 is formed by using the computer 90, which is depicted in FIG. 2, for example, the processor 91 executes a program to perform processing of manipulating a target file and processing of creating history information. For example, the processor 91 executes a program to perform processing of checking an environment and a set-up for manipulation of a target file and to perform control of a monitoring device for monitoring manipulation of a target file. Further, for example, the processor 91 executes a program to control the communication I/F 94 and performs processing of acquiring content that includes a target file from the management server 130 and transmitting history information to the management server 130. In addition, when the user apparatus 120 is enabled to function as the user-side node 220, the processor 91 executes a program to function as the user-side node 220.

In a case where the management server 130 is formed by using the computer 90, which is depicted in FIG. 2, for example, the processor 91 executes a program to control the communication I/F 94 and transmits and receives various kinds of data via communication with the provider apparatus 110 and the user apparatus 120. Content received from the provider apparatus 110 is stored and retained, for example, in the main memory 92 or the HDD 93. Further, history information received from the user apparatus 120 is stored and retained, for example, in the main memory 92 or the HDD 93, and the processor 91 executes a program to provide a management function to manage the history information.

### History Information

Next, history information created by the user apparatus 120 will be described. History information contains a record of an event that occurred in relation to manipulation of a target file on the user apparatus 120. History information contains information to specify an event, and a method of recording the information and a data format of the history information are not limited to any specific method and format. For example, the time that an event occurred, information describing an event, and a hash value of these pieces of information related to the event may be combined to record history information. In this case, these pieces of information related to the event is associated with the hash value and stored in the management server 130.

In the following description, a specific example of history information will be described. In the example, a target file is assumed to be a document file, and manipulation is assumed to be document-file viewing. A description will be given of history information regarding events that occur during manipulation to view a document file contained in content acquired from the provider apparatus 110. Examples of events for which history information is created include acquisition of content, start of document-file viewing, specific events during viewing, termination of viewing, and discarding of content, and a case where history information is created for each of these events will be described herein.

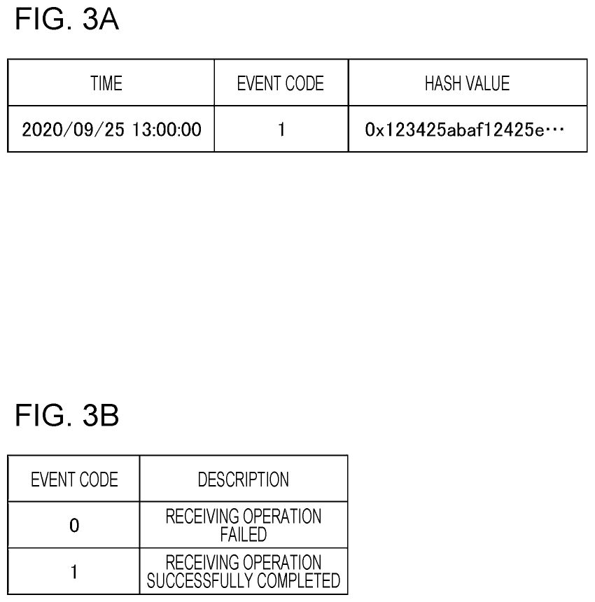

FIGS. 3A and 3B depict an example of history information created in response to receiving of content. FIG. 3A depicts an example of a structure of the history information, and FIG. 3B depicts descriptions of the events. The history information depicted in FIG. 3A contains a record indicating whether manipulation to acquire content was successfully completed as an event that occurs when the user apparatus 120 acquires content from the management server 130. In the following description, acquiring content from the management server 130 is referred to as a “receiving operation”. The history information depicted in FIG. 3A includes time information (denoted by “time” in FIG. 3A), code information (denoted by “event code” in FIG. 3A), and a hash value. The time information represents the date and time that the content was received. The code information represents a code indicating a description of the event that occurred. The hash value is obtained by converting into a hash value the sum of the numerical data representing the time information and the numerical data representing the code information.

As depicted in FIG. 3A, an event that occurred is specified by using a code assigned in advance to each event that can occur in relation to manipulation to receive content. In the example depicted in FIG. 3B, an item “receiving operation failed” indicating that content was not successfully received and an item “receiving operation successfully completed” indicating that content was successfully received are designated as events that can occur in relation to an operation of receiving content. A code “0” is assigned to the former event and a code “1” is assigned to the latter event. Thus, the code “1” recorded as the “event code” in the example depicted in FIG. 3A indicates that content was successfully received.

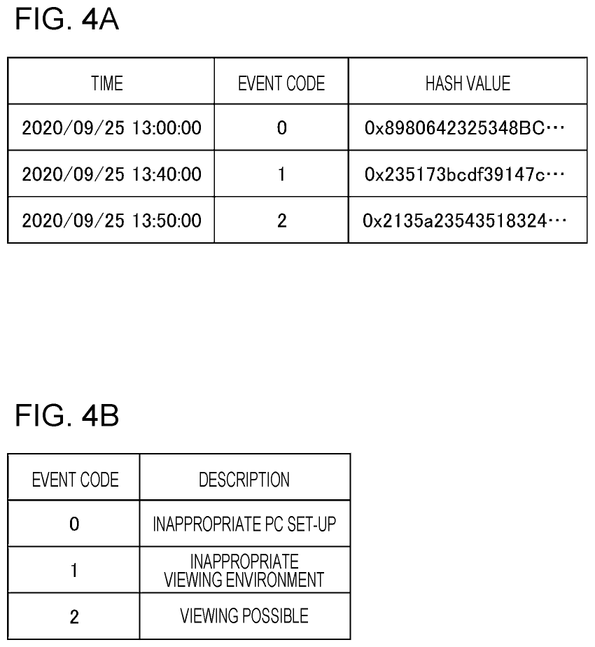

FIGS. 4A and 4B depict an example of history information created in response to manipulation to start document-file viewing. FIG. 4A depicts an example of a structure of the history information, and FIG. 4B depicts descriptions of the events. The history information depicted in FIG. 4A contains records of results of initially performed checking processes as events that occur when manipulation to start viewing a document file contained in the content is performed on the user apparatus 120. The history information depicted in FIG. 4A includes time information, code information, and hash values. The time information represents the date and time that the manipulation to start document-file viewing was performed. The code information represents a code indicating a description of the event that occurred. The hash value is obtained by converting into a hash value the sum of the numerical data representing the time information and the numerical data representing the code information.

As depicted in FIG. 4A, an event that occurred is specified by using a code assigned in advance to each event that can occur in relation to manipulation to start document-file viewing. In the example depicted in FIG. 4B, an item “inappropriate PC set-up” indicating an inappropriate apparatus set-up of the user apparatus 120, an item “inappropriate viewing environment” indicating an inappropriate environment for document-file viewing, and an item “viewing possible” indicating an appropriate environment for document-file viewing are designated as results of the checking process performed at the time of starting document-file viewing. A code “0” is assigned to the item “inappropriate PC set-up”, a code “1” is assigned to the item “inappropriate viewing environment”, and a code “2” is assigned to the item “viewing possible”. In the example depicted in FIG. 4A, checking results “inappropriate PC set-up”, “inappropriate viewing environment”, and “viewing possible” are listed in this order from the top.

A description will be given herein of procedures of a checking process initially performed when manipulation to start document-file viewing is performed. In the following description, the checking process is referred to as an “initial checking process”. The initial checking process is performed as a function of an execution program in content. When manipulation to start document-file viewing is performed on the user apparatus 120, the user apparatus 120 first checks the set-up of the user apparatus 120. Specifically, the user apparatus 120 checks whether the set-up of the user apparatus 120 satisfies the requirement to monitor document-file viewing. If the set-up of the user apparatus 120 does not satisfy the requirement, the checking process results in the “inappropriate PC set-up”. In contrast, if the set-up of the user apparatus 120 satisfies the requirement, the user apparatus 120 next checks the environment surrounding the user apparatus 120. Specifically, the user apparatus 120 checks whether the environment surrounding the user apparatus 120 satisfies the requirement specified as an environment in which the document file can be viewed. In the following description, the requirement specified as an environment in which the document file can be viewed is referred to as a “viewing condition”. If the environment surrounding the user apparatus 120 does not satisfy the viewing condition, the checking process results in the “inappropriate viewing environment”. In contrast, if the environment surrounding the user apparatus 120 satisfies the viewing condition, the checking process results in the “viewing possible”. If the checking process results in the “viewing possible”, for example, the document file to be viewed is presented on a display screen of the user apparatus 120, and the document file becomes viewable.

In this way, an execution program prepares a target file for manipulation on the user apparatus 120 through the initial checking process. The execution program also checks whether a set-up condition determined in advance to allow manipulation of a target file on the user apparatus 120 is satisfied and if it is determined by using this checking function that the set-up condition is satisfied, the execution program allows the target file to be prepared for manipulation. The execution program also determines whether an environment in which the target file is to be manipulated is categorized as a predetermined situation, and if it is determined by using this determining function that the environment for manipulation is categorized as the predetermined situation, the execution program allows the target file to be prepared for manipulation.

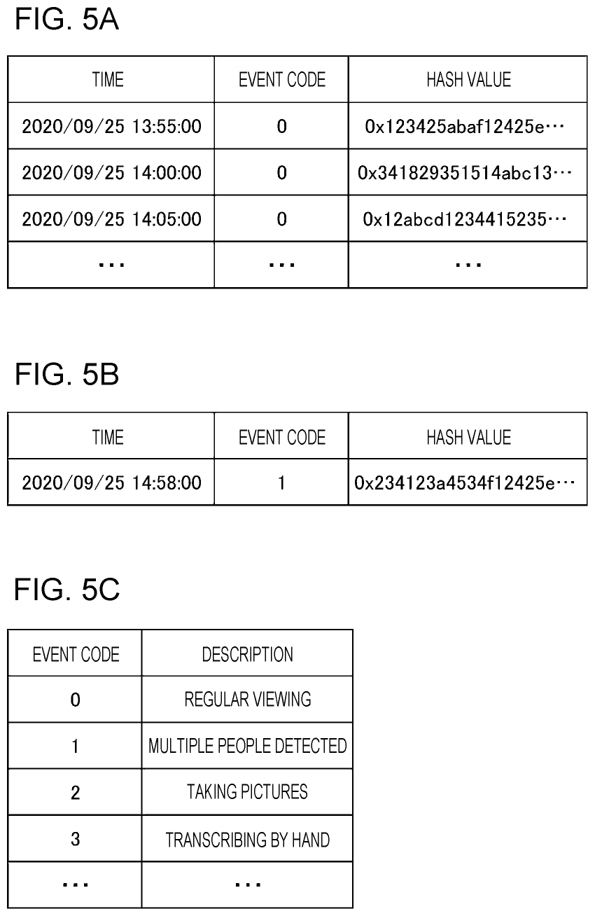

FIGS. 5A, 5B, and 5C depict an example of history information based on events during document-file viewing. FIG. 5A depicts an example of a structure of history information that corresponds to regular viewing, FIG. 5B depicts an example of a structure of history information that corresponds to occurrence of an irregular situation during viewing, and FIG. 5C depicts descriptions of the events. The history information depicted in FIGS. 5A and 5B contains records of events that occurred during document-file viewing performed on the user apparatus 120. Examples of an event to be recorded in the history information include an event that can occur during regular viewing and an event designated as an irregular situation during viewing. In the following description, the former event is referred to as a “regular event”, and the latter event is referred to as an “irregular event”. Thus, FIG. 5A depicts an example of history information based on a regular event, and FIG. 5B depicts an example of history information based on an irregular event.

Examples of a regular event include a case where manipulation is performed as a regular operation during viewing. Specifically, manipulation such as altering the display boundary of a document file being viewed and editing a document file within the authority granted to a user may be designated as a regular event. When manipulation designated in advance as a regular event is performed, history information based on the occurrence of the regular event is created. In addition, a situation in which a document file is being viewed without occurrence of an irregular event may be designated as a regular event, and history information based on the regular event may be created periodically. In the example depicted in FIG. 5A, history information based on a regular event is created every five minutes. Events categorized as a regular event are specified in advance in accordance with, for example, a specification or a security policy of a system to which the present exemplary embodiment is applied.

Examples of an irregular event include a case where a target file is manipulated in a predetermined irregular situation. Examples of an irregular event include a case where an operation prohibited during viewing is performed. In addition, if the set-up of the user apparatus 120 or the viewing environment changes from the set-up or the environment that was checked through the initial checking process performed at the time of starting viewing, resulting in a situation in which the requirement to allow viewing is not satisfied, such a situation may be designated as an irregular event. When an event designated in advance as an irregular event occurs, history information based on the occurrence of the irregular event is created. Events categorized as an irregular event are specified in advance in accordance with, for example, a specification or a security policy of a system to which the present exemplary embodiment is applied.

The history information depicted in FIGS. 5A and 5B includes time information, code information, and hash values. The time information represents the date and time that a regular event or an irregular event occurred. The code information represents a code indicating a description of the event that occurred. Each hash value is obtained by converting into a hash value the sum of the numerical data representing the time information and the numerical data representing the code information.

As depicted in FIGS. 5A and 5B, an event that occurred is specified by using a code assigned in advance to each event that can occur in relation to manipulation during document-file viewing. In the example depicted in FIG. 5C, a code “0” is assigned to a regular event (denoted by “regular viewing” in FIG. 5C). Codes such as “1”, “2”, and “3” are assigned to irregular events in accordance with a kind of event. Specifically, when two or more people who use the user apparatus 120 are detected (denoted by “multiple people detected” in FIG. 5C), the code “1” is assigned. When a user who tries to take a picture of the screen of the user apparatus 120 is detected (denoted by “taking pictures” in FIG. 5C), the code “2” is assigned. Further, when a user who tries to transcribe by hand a presentation on the screen of the user apparatus 120 is detected (denoted by “transcribing by hand” in FIG. 5C), the code “3” is assigned. These irregular events are detected, for example, by analyzing an image captured by a camera connected to the user apparatus 120. The example depicted in FIG. 5A represents a case where monitoring performed every five minutes detected a “regular viewing” situation. Further, the example depicted in FIG. 5B represents a case where two or more people were detected as users.

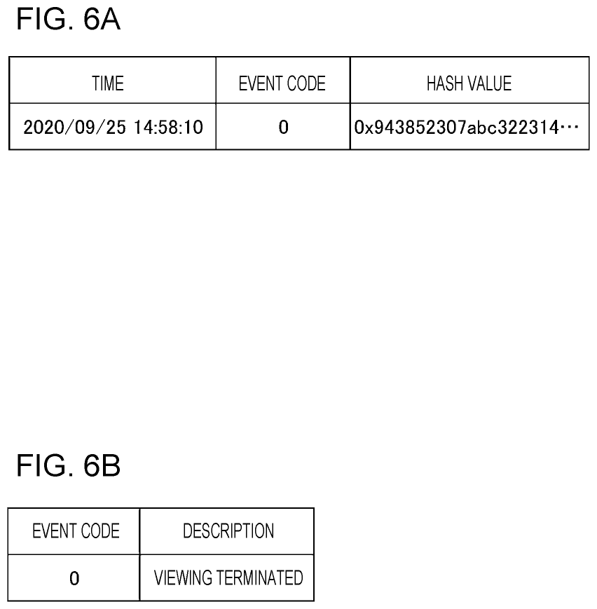

FIGS. 6A and 6B depict an example of history information created in response to the termination of document-file viewing. FIG. 6A depicts an example of a structure of the history information, and FIG. 6B depicts a description of the event. The history information depicted in FIG. 6A contains a record of the termination of a state in which document-file viewing is allowed by the user apparatus 120. Specifically, for example, the history information indicates that the display screen for a document file was closed. The history information depicted in FIG. 6A includes time information, code information, and a hash value. The time information represents the date and time that an operation to terminate document-file viewing was performed on the user apparatus 120. The code information represents a code indicating a description of the event that occurred. The hash value is obtained by converting into a hash value the sum of the numerical data representing the time information and the numerical data representing the code information.

If an operation to terminate document-file viewing results in failure, the state in which document-file viewing is allowed by the user apparatus 120 continues, and no change occurs. Thus, only successful completion of the operation to terminate viewing may be designated as an event for which history information is created. In this example, only history information containing a record of successful completion of the operation to terminate viewing is created. As depicted in FIG. 6B, a code “0” is assigned to this event (denoted by “viewing terminated” in FIG. 6B).

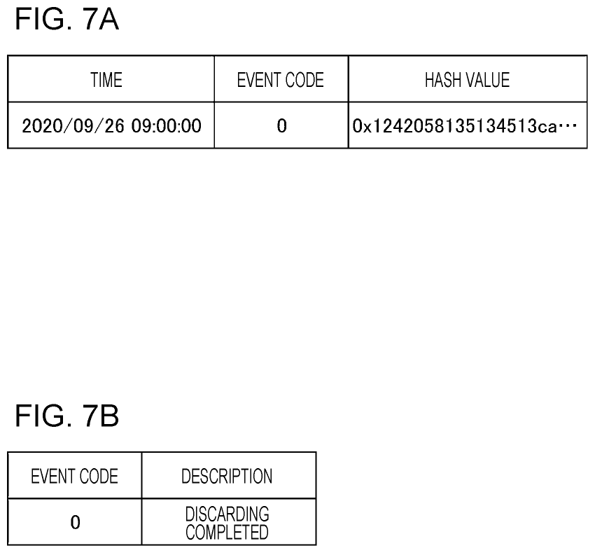

FIGS. 7A and 7B depict an example of history information created in response to discarding of content containing a document file. FIG. 7A depicts an example of a structure of the history information, and FIG. 7B depicts a description of the event. The history information depicted in FIG. 7A contains a record of successful completion of discarding of the content by using the user apparatus 120. The history information depicted in FIG. 7A includes time information, code information, and a hash value. The time information represents the date and time that the content was discarded. The code information represents a code indicating a description of the event that occurred. The hash value is obtained by converting into a hash value the sum of the numerical data representing the time information and the numerical data representing the code information.

If content is not successfully discarded, the state in which the user apparatus 120 retains the content continues, and no change occurs. Thus, only successful completion of discarding of content may be designated as an event for which history information is created. In this example, only history information containing a record of successful completion of discarding of the content is created. As depicted in FIG. 7B, a code “0” is assigned to this event (denoted by “discarding completed” in FIG. 7B).

### Monitoring Operation of Entire System

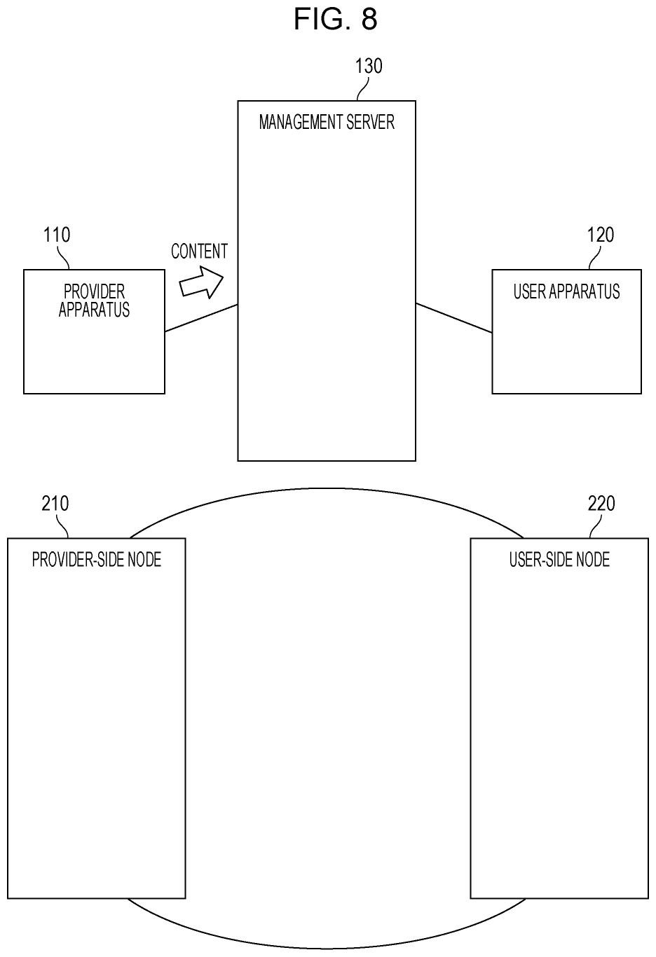

Next, operations of the user apparatus 120 to monitor manipulation of a target file will be described. In the present exemplary embodiment, content containing a combination of a target file and an execution program to manipulate the target file is provided from the provider apparatus 110 to the user apparatus 120, and the target file is manipulated on the user apparatus 120 by using the execution program contained in the content. Then, a function implemented on the user apparatus 120 by using the execution program monitors manipulation of the target file on the user apparatus 120. In the following description, monitoring operation will be described for each procedure with reference to a corresponding figure (FIGS. 8 to 16). The description will also be given below of the example in which the target file is assumed to be a document file and manipulation of the target file is assumed to be document-file viewing.

FIG. 8 depicts how the provider apparatus 110 provides content. The content containing a target file and an execution program is transmitted from the provider apparatus 110 to the management server 130. The management server 130 stores and retains the received content in a memory device (such as the HDD 93 depicted in FIG. 2).

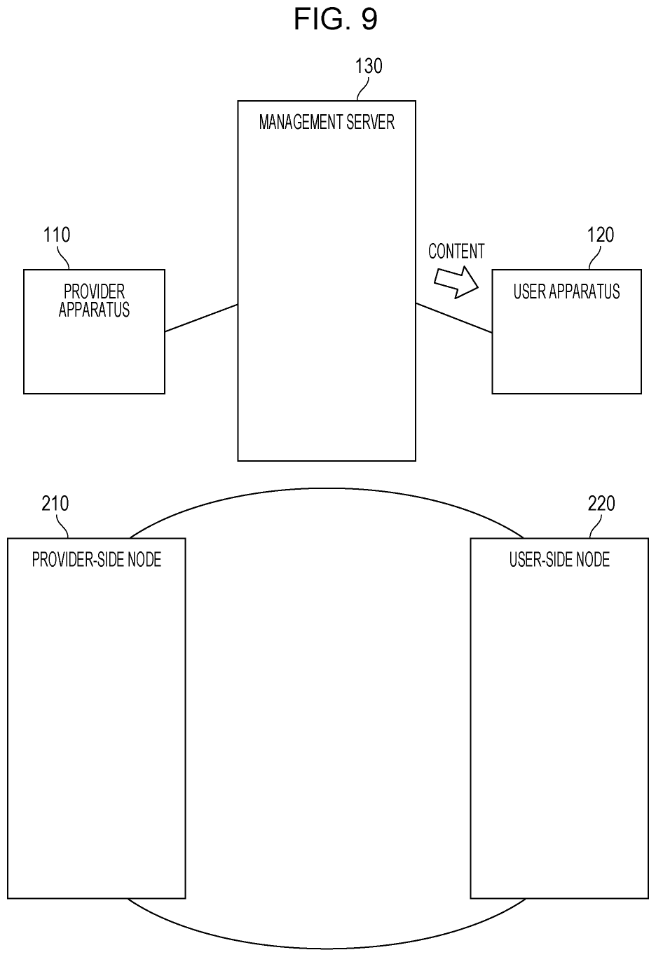

FIG. 9 depicts how the user apparatus 120 receives the content. The user apparatus 120 accesses the management server 130 and sends a request to transmit the content. The management server 130 transmits the retained content to the user apparatus 120 in accordance with the request from the user apparatus 120.

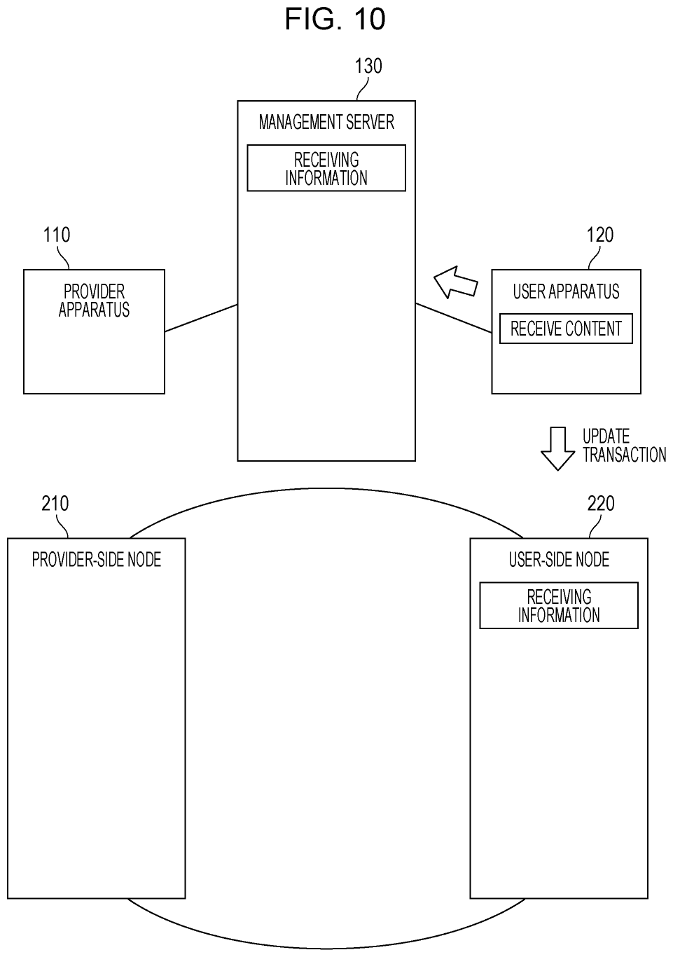

FIG. 10 depicts how the user apparatus 120 creates history information based on receiving of the content. In response to receiving of the content, the user apparatus 120 creates based on the manipulation to receive the content such history information as is depicted in FIG. 3A and guarantee data for this history information. Then, the user apparatus 120 transmits the history information to the management server 130. The management server 130 stores the received history information (denoted by “receiving information” in FIG. 10) in the memory device (such as the HDD 93 depicted in FIG. 2) and manages the history information. In addition, the user apparatus 120 transmits the guarantee data to the user-side node 220 in the blockchain system 200 and updates a transaction in the blockchain. The creation of the history information and the guarantee data in response to receiving of the content, the transmission to the management server 130, and updating of the blockchain are performed, for example, as a function implemented by using a program that is installed on the user apparatus 120 in advance.

The data format and content of the guarantee data are not limited to any particular format and content as long as the guarantee data is available to guarantee the content of the history information. For example, only a hash value contained in the history information may be used as the guarantee data, or the history information itself may be used as the guarantee data. In the examples depicted in FIGS. 10 to 16, it is assumed that history information managed by the management server 130 is used as the guarantee data and managed by the blockchain system 200. FIG. 10 depicts how the guarantee data (denoted by “receiving information” in FIG. 10) is recorded in the transaction at the user-side node 220.

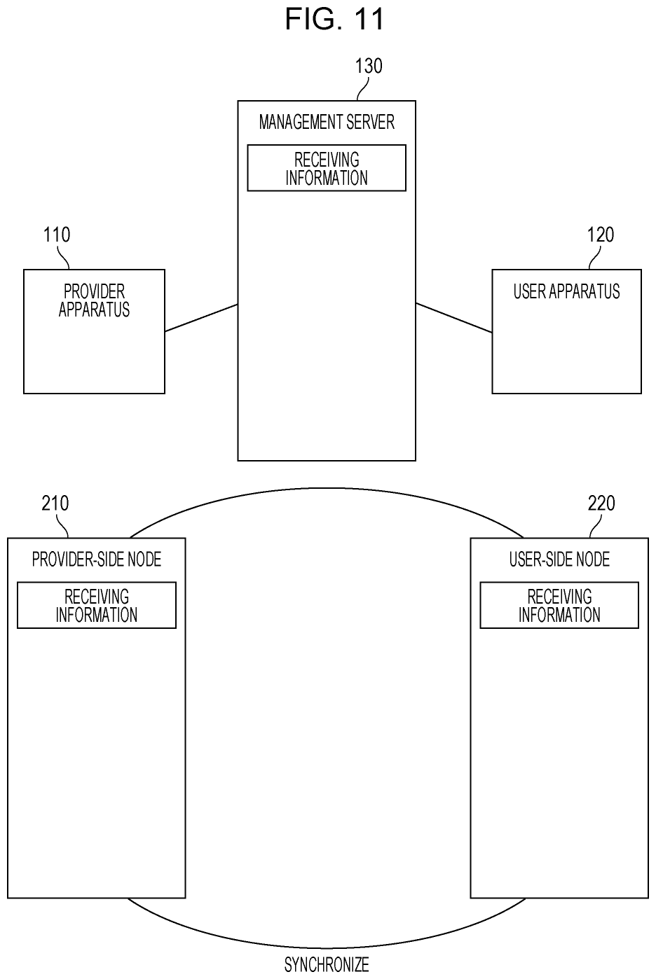

FIG. 11 depicts synchronization of transactions in the blockchain. After a transaction at the user-side node 220 is updated in the blockchain system 200, the user-side node 220 and the provider-side node 210 communicate with each other and try to synchronize transactions between them. FIG. 11 depicts how the synchronization with the user-side node 220 enables the provider-side node 210 to record in the transaction the same guarantee data (denoted by “receiving information” in FIG. 11) as is recorded at the user-side node 220.

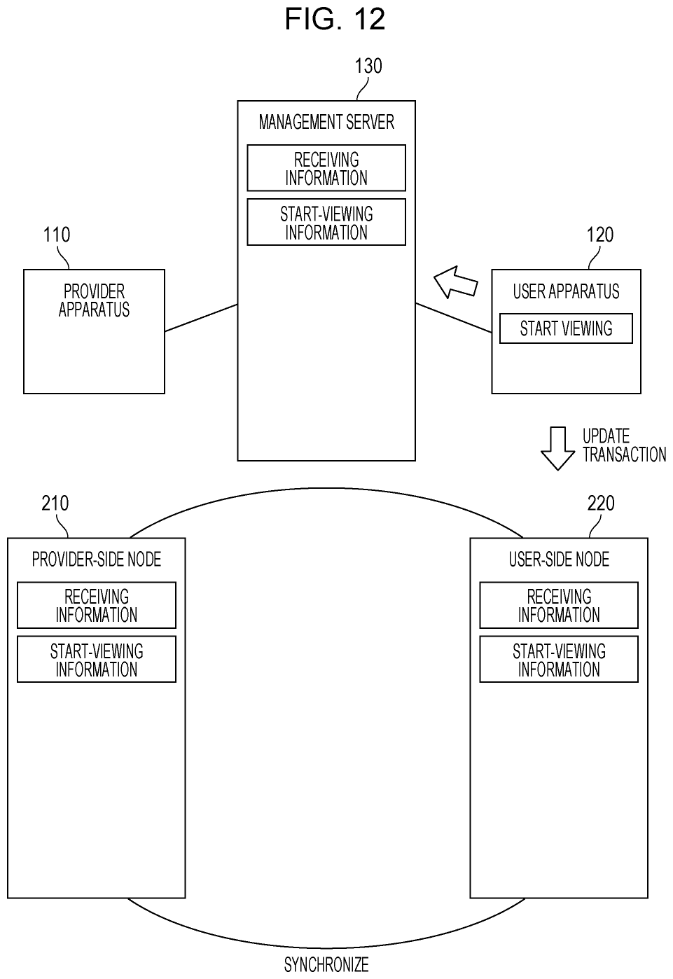

FIG. 12 depicts an operation performed by the user apparatus 120 in response to manipulation to start document-file viewing. When the manipulation to start document-file viewing is performed (denoted by “start viewing” in FIG. 12) by using the execution program contained in the content, the user apparatus 120 creates based on the manipulation such history information as is depicted in FIG. 4A and guarantee data for this history information. Then, the user apparatus 120 transmits the history information to the management server 130. The management server 130 stores the received history information (denoted by “start-viewing information” in FIG. 12) in the memory device and manages the history information. In this way, the “start-viewing information” is added as the history information to be managed by the management server 130.

In addition, the user apparatus 120 transmits to the user-side node 220 in the blockchain system 200 the guarantee data based on the manipulation to start viewing and updates a transaction in the blockchain. After the transaction at the user-side node 220 is updated, the user-side node 220 and the provider-side node 210 try to synchronize transactions between them. In this way, the guarantee data (denoted by “start-viewing information” in FIG. 12) for the history information created in response to the manipulation to start viewing is added to the blockchain managed by the blockchain system 200. The creation of the history information and the guarantee data in response to the manipulation to start viewing, the transmission to the management server 130, and updating of the blockchain are performed, for example, as a function implemented by using the execution program contained in the content.

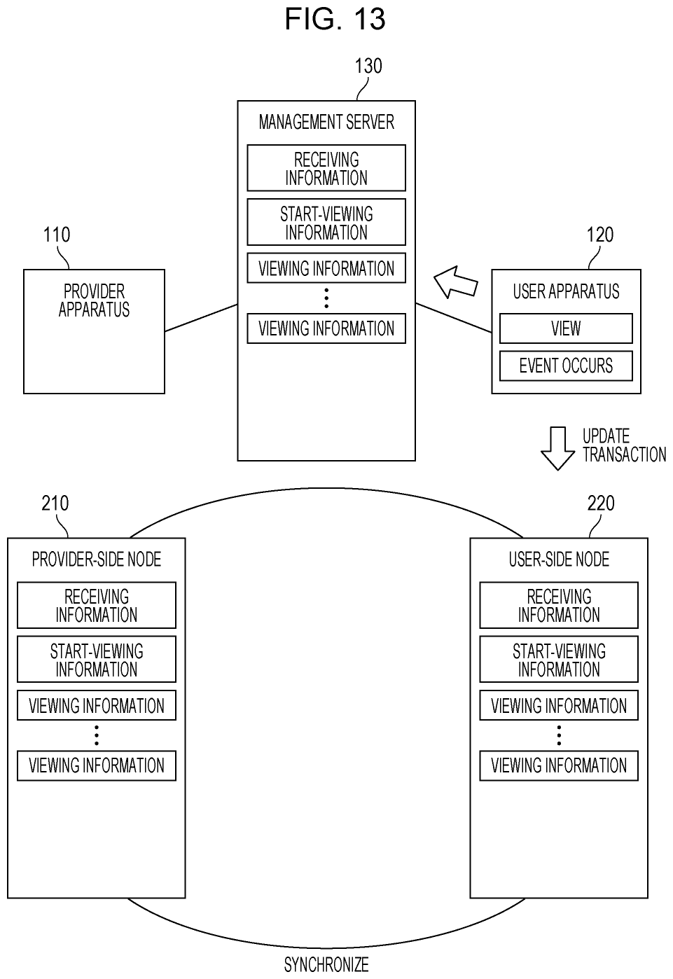

FIG. 13 depicts an operation performed by the user apparatus 120 in response to occurrence of a regular event during document-file viewing. After a regular event occurs during document-file viewing (denoted by “view” and “event occurs” in FIG. 13), the user apparatus 120 creates based on the occurrence of the event such history information as is depicted in FIG. 5A and guarantee data for this history information. A regular event can occur multiple times during document-file viewing. Thus, history information and guarantee data based on the occurrence of a regular event can be created multiple times. Further, even if specific manipulation is not performed, history information and guarantee data based on the occurrence of a regular event during document-file viewing may be created periodically to indicate that viewing is performed in a normal manner.

The user apparatus 120 creates history information and guarantee data based on the occurrence of a regular event and then transmits the history information to the management server 130. The management server 130 stores the received history information (denoted by “viewing information” in FIG. 13) in the memory device and manages the history information. In this way, the “viewing information” is added as the history information to be managed by the management server 130. As described above, history information based on the occurrence of a regular event can be created multiple times. FIG. 13 depicts how multiple pieces of history information each based on a regular event are managed.

In addition, the user apparatus 120 transmits the guarantee data based on a regular event to the user-side node 220 in the blockchain system 200 and updates a transaction in the blockchain. After the transaction at the user-side node 220 is updated, the user-side node 220 and the provider-side node 210 try to synchronize transactions between them. In this way, the guarantee data (denoted by “viewing information” in FIG. 13) for the history information created in response to the occurrence of a regular event is added to the blockchain managed by the blockchain system 200. FIG. 13 depicts how multiple pieces of guarantee data each based on a regular event are recorded at the user-side node 220 and at the provider-side node 210. The creation of the history information and the guarantee data in response to the occurrence of a regular event, the transmission to the management server 130, and updating of the blockchain are performed, for example, as a function implemented by using the execution program contained in the content.

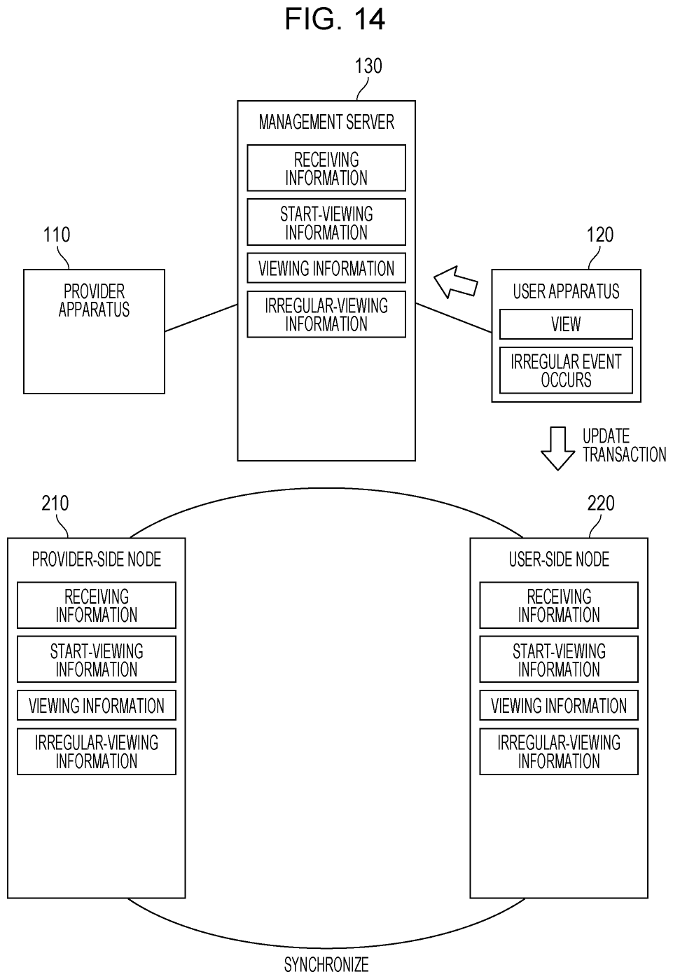

FIG. 14 depicts an operation performed by the user apparatus 120 in response to occurrence of an irregular event during document-file viewing. After an irregular event occurs during document-file viewing (denoted by “view” and “irregular event occurs” in FIG. 14), the user apparatus 120 creates based on the occurrence of the irregular event such history information as is depicted in FIG. 5B and guarantee data for this history information. In response to the occurrence of the irregular event, the document-file viewing is terminated.

The user apparatus 120 creates history information and guarantee data based on the occurrence of the irregular event and then transmits the history information to the management server 130. The management server 130 stores the received history information (denoted by “irregular-viewing information” in FIG. 14) in the memory device and manages the history information. In this way, the “irregular-viewing information” is added as the history information to be managed by the management server 130. FIG. 14 depicts how history information based on an irregular event was created after history information based on a regular event was created.

In addition, the user apparatus 120 transmits the guarantee data based on the irregular event to the user-side node 220 in the blockchain system 200 and updates a transaction in the blockchain. After the transaction at the user-side node 220 is updated, the user-side node 220 and the provider-side node 210 try to synchronize transactions between them. In this way, the guarantee data (denoted by “irregular-viewing information” in FIG. 14) for the history information created in response to the occurrence of the irregular event is added to the blockchain managed by the blockchain system 200. The creation of the history information and the guarantee data in response to the occurrence of the irregular event, the transmission to the management server 130, and updating of the blockchain are performed, for example, as a function implemented by using the execution program contained in the content.

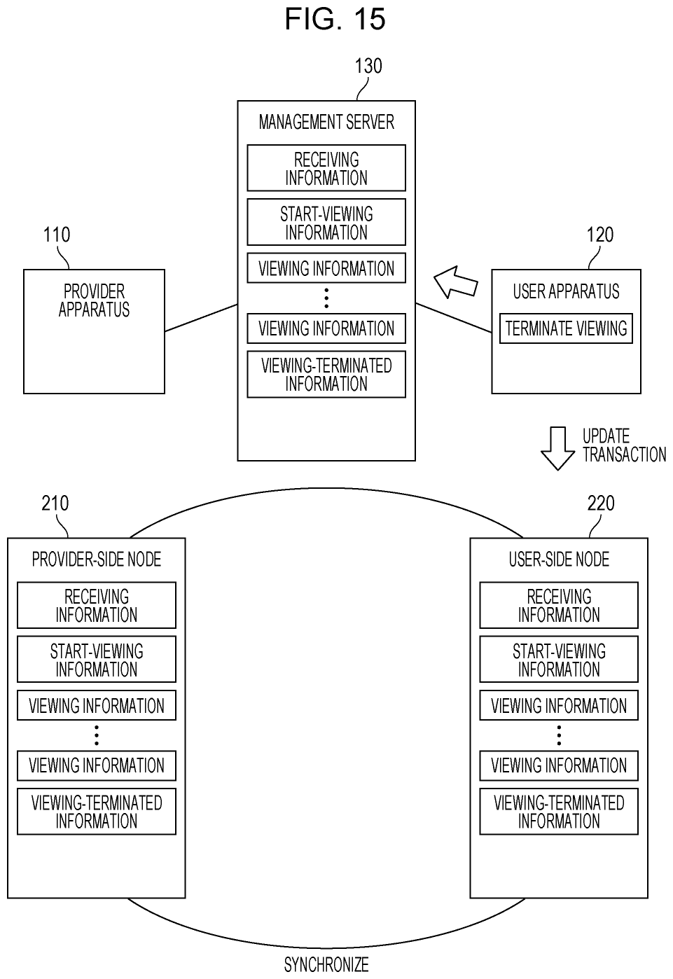

FIG. 15 depicts an operation performed by the user apparatus 120 in response to manipulation to terminate document-file viewing. After the manipulation to terminate document-file viewing is performed (denoted by “terminate viewing” in FIG. 15), the user apparatus 120 creates based on the manipulation such history information as is depicted in FIG. 6A and guarantee data for this history information. Then, the user apparatus 120 transmits the history information to the management server 130. The management server 130 stores the received history information (denoted by “viewing-terminated information” in FIG. 15) in the memory device and manages the history information. In this way, the “viewing-terminated information” is added as the history information to be managed by the management server 130. FIG. 15 depicts how history information based on the manipulation to terminate viewing was created after multiple pieces of history information each based on a regular event were created.

In addition, the user apparatus 120 transmits to the user-side node 220 in the blockchain system 200 the guarantee data based on the manipulation to terminate viewing and updates a transaction in the blockchain. After the transaction at the user-side node 220 is updated, the user-side node 220 and the provider-side node 210 try to synchronize transactions between them. In this way, the guarantee data (denoted by “viewing-terminated information” in FIG. 15) for the history information created in response to the manipulation to terminate viewing is added to the blockchain managed by the blockchain system 200. The creation of the history information and the guarantee data in response to the manipulation to terminate viewing, the transmission to the management server 130, and updating of the blockchain are performed, for example, as a function implemented by using the execution program contained in the content.

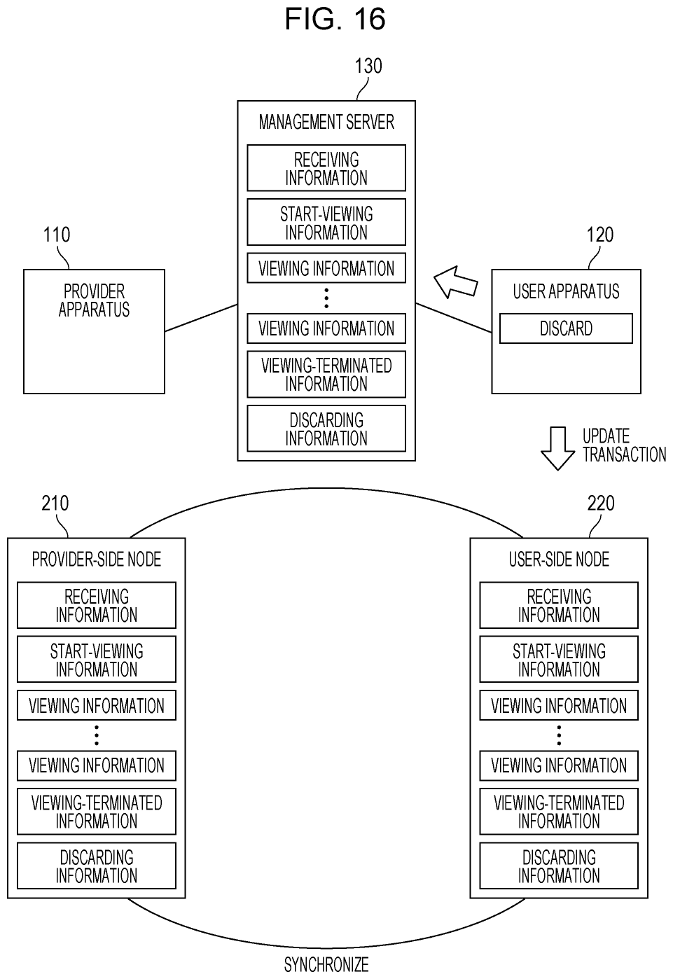

FIG. 16 depicts an operation performed by the user apparatus 120 in response to discarding of content. In response to manipulation to discard content (denoted by “discard” in FIG. 16), the user apparatus 120 creates based on the manipulation such history information as is depicted in FIG. 7A and guarantee data for this history information. Then, the user apparatus 120 transmits the history information to the management server 130. The management server 130 stores the received history information (denoted by “discarding information” in FIG. 16) in the memory device and manages the history information. In this way, the “discarding information” is added as the history information to be managed by the management server 130. FIG. 16 depicts how history information based on the discarding of the content was created after multiple pieces of history information each based on a regular event were created and history information based on the manipulation to terminate viewing was created.

In addition, the user apparatus 120 transmits to the user-side node 220 in the blockchain system 200 the guarantee data based on the discarding of the content and updates a transaction in the blockchain. After the transaction at the user-side node 220 is updated, the user-side node 220 and the provider-side node 210 try to synchronize transactions between them. In this way, the guarantee data (denoted by “discarding information” in FIG. 16) for the history information created in response to the discarding of the content is added to the blockchain managed by the blockchain system 200. The creation of the history information and the guarantee data in response to the discarding of the content, the transmission to the management server 130, and updating of the blockchain are performed, for example, as a function implemented by using a program that is installed on the user apparatus 120 in advance.

FIGS. 15 and 16 depict an example of the operation in which the content is discarded after the document-file viewing is performed in a normal manner and terminated. In contrast, as depicted in FIG. 14, when an irregular event occurs during document-file viewing, history information and guarantee data based on the irregular event that occurred are created, and the document-file viewing is terminated. Then, history information and guarantee data are created in accordance with the termination of viewing. When viewing is terminated because of occurrence of an irregular event, the viewing is not terminated by user manipulation, but automatically terminated. However, since the operation to terminate the viewing is performed in a normal manner, history information and guarantee data created in this case are similar to the history information and the guarantee data created in the operation that is described with reference to FIGS. 6A, 6B, and 15 regarding the creation and management of the history information and the guarantee data. In contrast to the situation depicted in FIG. 15, however, the history information and the guarantee data based on the termination of the viewing are added to the management server 130 and the blockchain system 200, respectively, at a position that follows the history information or the guarantee data based on the irregular event.

When occurrence of an irregular event terminates document-file viewing, the user apparatus 120 may perform error handling such as outputting a message or an alarm sound to report the occurrence of the irregular event or the termination of the viewing. Such handling may be implemented, for example, by using a function added to the user apparatus 120 by an execution program contained in content.

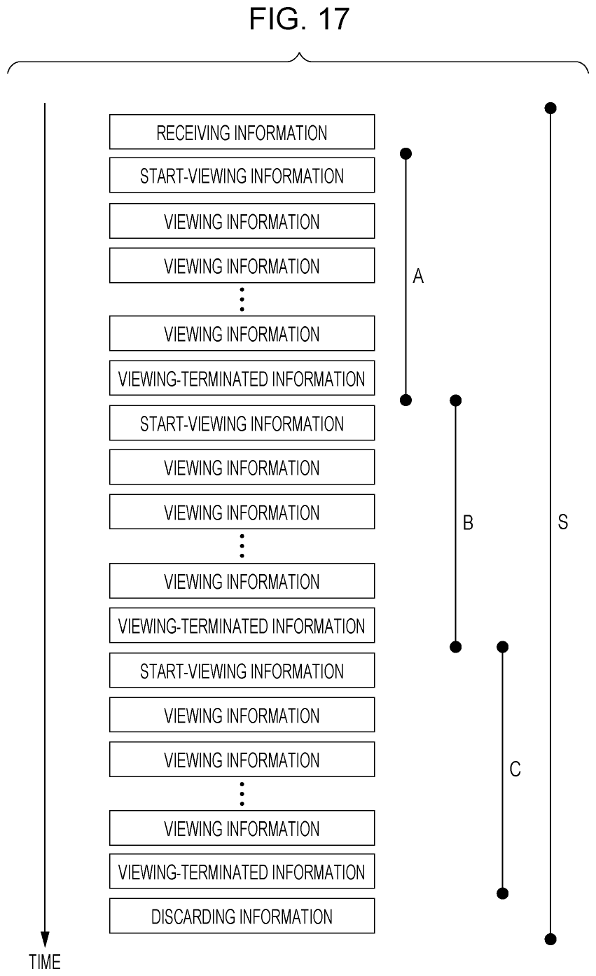

FIG. 17 depicts an example of history information created by a series of operations performed during regular document-file viewing. In the example depicted in FIG. 17, pieces of history information are created while content is received by the user apparatus 120, viewed multiple times, and thereafter discarded, and these pieces of information, which are managed by the management server 130, are depicted. These pieces of history information are categorized by using the names assigned to the history information depicted in FIGS. 8 to 16. In the following description, a period from the receiving to the discarding of the content is referred to as a life cycle of the content. In addition, a period from the start to the termination of document-file viewing is referred to as a viewing cycle. A document file is viewed once or multiple times during the life cycle of the content.

### Example of Creating History Information

In FIG. 17, it is assumed that time elapses from the top to the bottom as indicated by the downward arrow, and pieces of history information are arranged from the top in order of creation. In the example depicted in FIG. 17, the life cycle of the content is denoted by the range S. The document file contained in the content is viewed three times. The first viewing cycle is denoted by the range A, the second viewing cycle is denoted by the range B, and the third viewing cycle is denoted by the range C. Viewing procedures in each viewing cycle proceed as follows: the viewing is started, then a regular event occurs multiple times, and the viewing is terminated. After the third viewing cycle is complete, the content is discarded.

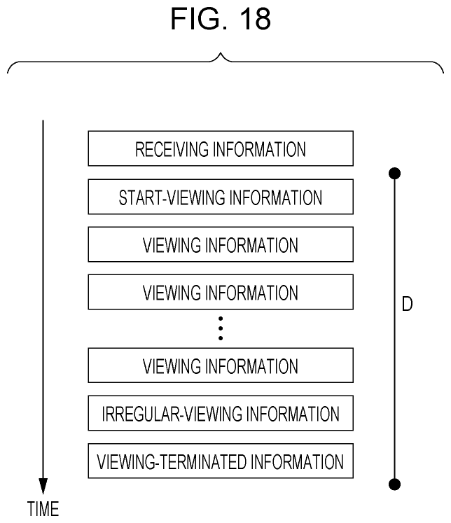

FIG. 18 depicts an example of history information created by a series of operations performed when an irregular event occurs during document-file viewing. In the example depicted in FIG. 18, after content is received by the user apparatus 120, an irregular event occurs during the first viewing cycle, and the viewing is terminated. Viewing procedures in the viewing cycle D depicted in FIG. 18 proceed as follows: the viewing is started, a regular event occurs multiple times, then an irregular event occurs, and the viewing is terminated. In this viewing cycle, the viewing is terminated automatically because of the occurrence of the irregular event or terminated by manipulation by the user who recognizes the occurrence of the irregular event.

### Operations Performed by User Apparatus 120

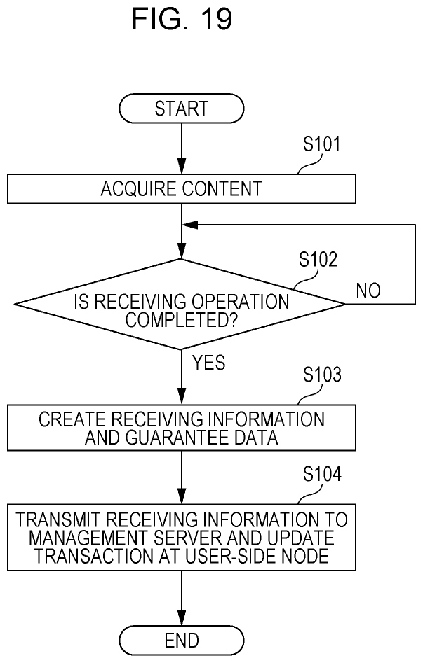

FIGS. 19 to 22 are flowcharts depicting examples of operations performed by the user apparatus 120. As an example, operations performed by the user apparatus 120 for document-file viewing are herein described separately for the operation of receiving content, the operation during a viewing cycle for a document file, and the operation of discarding content.

FIG. 19 depicts an operation performed by the user apparatus 120 when content is received. After acquiring content from the management server 130 (S101) and completing a receiving operation (S102), the user apparatus 120 creates history information and guarantee data for this history information (S103). The history information (denoted by “receiving information” in FIG. 19) is based on receiving of the content. Then, the user apparatus 120 transmits the history information to the management server 130 and updates a transaction at the user-side node 220 by using the guarantee data (S104). After the transaction at the user-side node 220 is updated, the user-side node 220 and the provider-side node 210 communicates with each other and synchronize transactions between them, and the guarantee data is managed by a blockchain.

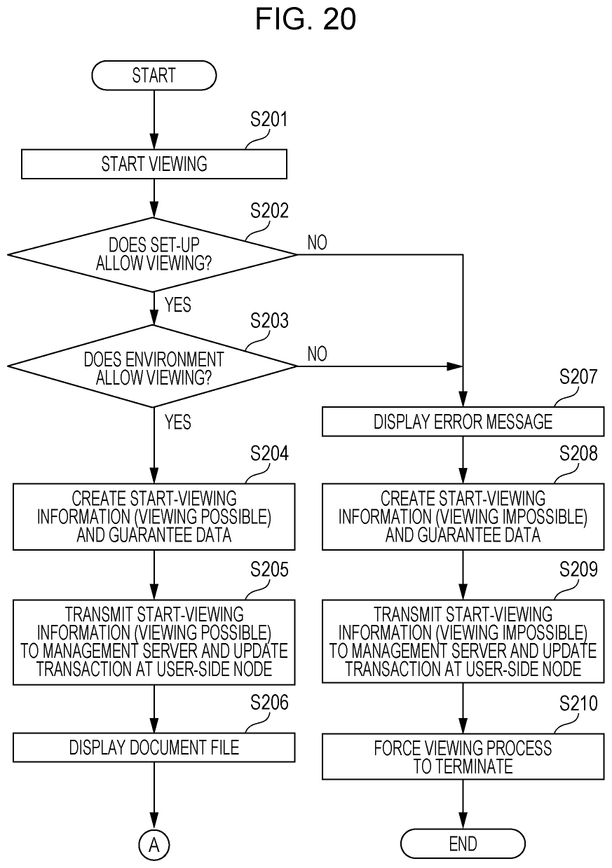

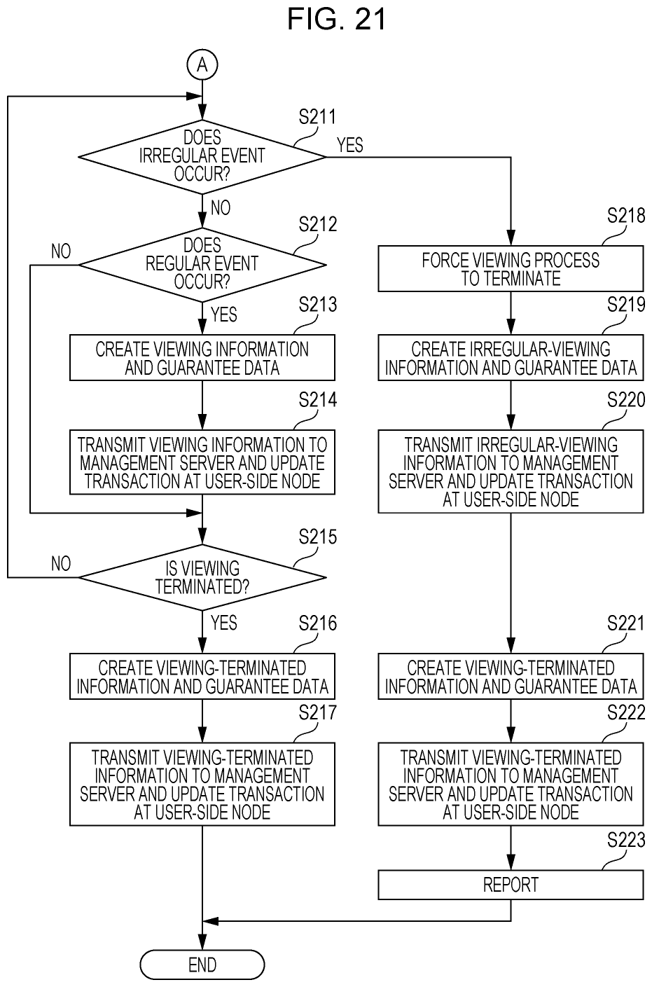

FIGS. 20 and 21 depict an operation performed by the user apparatus 120 in a viewing cycle. After manipulation to start viewing is performed on the user apparatus 120 (S201), the user apparatus 120 performs an initial checking process. In a case where the user apparatus 120 has a necessary set-up to monitor manipulation during viewing (YES in S202), the user apparatus 120 next checks a viewing environment. If the viewing environment allows document-file viewing (YES in S203), the user apparatus 120 creates history information and guarantee data for this history information (S204). The history information (denoted by “start-viewing information (viewing possible)” in FIG. 20) is based on a check result “viewing possible”. Then, the user apparatus 120 transmits the history information to the management server 130, updates the transaction at the user-side node 220 by using the guarantee data (S205), and displays the document file (S206).

In a case where the user apparatus 120 does not have a necessary set-up to monitor manipulation during viewing (NO in S202) or the viewing environment does not allow document-file viewing (NO in S203), the user apparatus 120 performs error handling. FIG. 20 depicts an example in which the user apparatus 120 displays an error message indicating an inappropriate set-up or an inappropriate viewing environment in accordance with the result of the initial checking process (S207) and the user apparatus 120 creates history information and guarantee data for this history information (S208). The history information (denoted by “start-viewing information (viewing impossible)” in FIG. 20) indicates the result of the initial checking process. Then, the user apparatus 120 transmits the history information to the management server 130, updates the transaction at the user-side node 220 by using the guarantee data (S209), and forces the document-file viewing process to terminate (S210).

After the document-file viewing starts, the user apparatus 120 monitors viewing status, and if a regular event occurs (NO in 5211 and YES in S212), the user apparatus 120 creates history information and guarantee data for this history information (S213). The history information (denoted by “viewing information” in FIG. 21) is based on the regular event that occurred. Then, the user apparatus 120 transmits the history information to the management server 130 and updates the transaction at the user-side node 220 by using the guarantee data (S214). Examples of a regular event include a case where an irregular event does not occur for a fixed period.

The user apparatus 120 continues to monitor the viewing status as described above until the document-file viewing terminates. After manipulation to terminate the viewing is performed (S215), the user apparatus 120 creates history information and guarantee data for this history information (S216). The history information (denoted by “viewing-terminated information” in FIG. 21) indicates termination of the viewing. Then, the user apparatus 120 transmits the history information to the management server 130 and updates the transaction at the user-side node 220 by using the guarantee data (S217).

In a case where an irregular event occurs during the document-file viewing (YES in S211), the user apparatus 120 forces the document-file viewing to terminate (S218). The user apparatus 120 forces the document-file viewing to terminate, for example, by closing the document file being displayed. Next, the user apparatus 120 creates history information and guarantee data for this history information (S219). The history information (denoted by “irregular-viewing information” in FIG. 21) is based on the irregular event that occurred. Then, the user apparatus 120 transmits the history information to the management server 130 and updates the transaction at the user-side node 220 by using the guarantee data (S220). Along with forcing the document-file viewing to terminate, the user apparatus 120 creates history information and guarantee data for this history information (S221). The history information (denoted by “viewing-terminated information” in FIG. 21) indicates termination of the viewing. Then, the user apparatus 120 transmits the history information to the management server 130 and updates the transaction at the user-side node 220 by using the guarantee data (S222). Subsequently, the user apparatus 120 reports the occurrence of the irregular event to the user (S223). For example, a message or an alarm sound is output to report the occurrence of the irregular event.

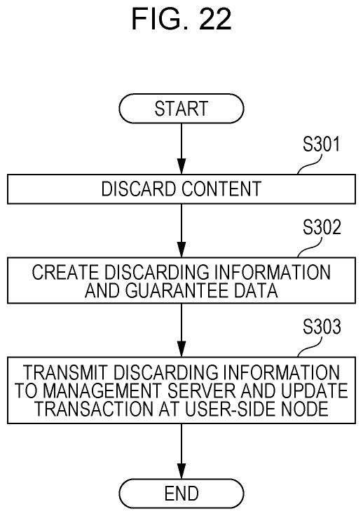

FIG. 22 depicts an operation performed by the user apparatus 120 when content is discarded. After manipulation to discard content is performed on the user apparatus 120 (S301), the user apparatus 120 creates history information and guarantee data for this history information (S302). The history information (denoted by “discarding information” in FIG. 22) is based on discarding of the content. Then, the user apparatus 120 transmits the history information to the management server 130 and updates the transaction at the user-side node 220 by using the guarantee data (S303).

### Examples of Monitoring Method

Examples of a method for monitoring an environment for manipulation of a target file in an initial checking process or for monitoring an irregular event during manipulation include acquiring and analyzing images or voices in the surroundings of the user apparatus 120. The images or voices are captured by using a camera or a microphone that is connected to or built into the user apparatus 120. For some kinds of irregular events, a sensor with which to acquire information required to detect such irregular events may be used, and occurrence of such irregular events may be detected by analyzing the information acquired by using the sensor. An event to be detected as an irregular event is not limited to a particular type of event and is defined individually in accordance with an information system to which the present exemplary embodiment is applied. For example, an irregular event for a monitoring target may be defined in accordance with an information-security policy or other polices determined for information managed by the information processing system according to the present exemplary embodiment.

For example, if a viewing condition that only one user having the authority be allowed to view a document file being a target file is set, presence of two or more people around the user apparatus 120 may be detected as an irregular event. In such a case, for example, images of the surroundings of the user apparatus 120 are captured by using a camera built into the user apparatus 120 or a camera controllable by the user apparatus 120, and captured images are analyzed to determine whether two or more people are detected. If two or more people are detected, this event may be designated as an irregular event. Alternatively, voices in the surroundings of the user apparatus 120 may be captured by using a microphone built into the user apparatus 120 or a microphone controllable by the user apparatus 120, and captured voices may be analyzed to determine whether voices of two or more people are detected. If two or more people are detected, this event may be designated as an irregular event. Existing analyzing techniques may be used to detect two or more people in image data or detect two or more speakers in voice data.

For example, if taking a picture of the screen of the user apparatus 120 on which a document file being a target file is displayed is forbidden, a movement of directing at the screen of the user apparatus 120 a smartphone or other devices capable of capturing an image may be detected as an irregular event. In such a case, for example, images of the user who uses the user apparatus 120 are captured by using a camera built into the user apparatus 120 or a camera controllable by the user apparatus 120, and captured images are analyzed. If an analysis result that is obtained indicates that a device having an image-capturing function is pointing at the screen of the user apparatus 120, this event may be designated as an irregular event. Existing analyzing techniques may be used to analyze the images.

Further, for example, if transcribing a displayed document is forbidden while the user apparatus 120 displays a document file being a target file, an event in which the user repeats, multiple times in a fixed period, alternately watching the screen of the user apparatus 120 and moving a hand while looking at the hand may be detected as an irregular event. In such a case, for example, images of the user who uses the user apparatus 120 are captured by using a camera built into the user apparatus 120 or a camera controllable by the user apparatus 120, and captured images are analyzed. If the above event is obtained as the analysis result, this event may be designated as an irregular event. Existing analyzing techniques may be used to analyze the images.

Further, for example, if a viewing condition is set that a filter to limit the range of viewing angle be attached to the display device (for example, the display device 95 depicted in FIG. 2) of the user apparatus 120 while the user apparatus 120 displays a document file being a target file, manipulation to detach the filter may be detected as an irregular event. In such a case, for example, a sensor with which to determine whether the filter is attached may be installed into the display device, and if information indicating that the filter is detached is obtained from the sensor, this event may be designated as an irregular event. Existing sensor techniques may be used to provide such a sensor. For example, an optical sensor may be disposed so that light illuminating the optical sensor is blocked by the attached filter.

Further, for example, if audio-recording of a displayed document is forbidden while the user apparatus 120 displays a document file being a target file, an event in which the user or other people read the displayed document aloud may be detected as an irregular event. In such a case, for example, voices recorded with a microphone built into the user apparatus 120 or a microphone controllable by the user apparatus 120 are analyzed, and if utterance continues for a fixed period or longer, this event may be designated as an irregular event. Further, the recorded voices may be subjected to a speech recognition process, and if a recognition result resembles the content of the displayed document, this event may be designated as an irregular event. Existing analyzing techniques may be used to perform these procedures.

Although some examples of events to be monitored as an irregular event have been described above, events to be monitored are not limited to the above examples. Further, various kinds of sensors may be controlled by the user apparatus 120 in accordance with a type of event to be detected as an irregular event. Whether a device and control capability are installed for the monitoring described above is checked in an initial checking process. For example, the initial checking process is executed by an execution program combined with a target file when manipulation of the target file starts. If it is determined in the initial checking process that a set-up required to detect an irregular event is not provided, the manipulation of the target file does not start (refer to FIG. 20). After it is determined in the initial checking process that a set-up required to detect an irregular event is provided, if the set-up is altered while the target file is manipulated, this event is detected as an irregular event.

The exemplary embodiment of the present disclosure has been described as above, but the technical scope of the present disclosure is not limited to the exemplary embodiment described above. For example, in the exemplary embodiment described above, after manipulation of a target file starts, history information and guarantee data are created by using a function of an execution program provided by the provider apparatus 110 along with the target file, and in response to receiving or discarding of content, history information and guarantee data are created by using a function of a program installed on the user apparatus 120 in advance. In contrast to the above exemplary embodiment, the initial checking process and monitoring may be performed by using a function of an execution program provided along with a target file, and all of the history information and guarantee data may be created by using a function of a program installed on the user apparatus 120 in advance. By contrast, in response to receiving or discarding of content, history information and guarantee data may be created by using a function of an execution program provided along with a target file. In such a case, content may have a function to create history information and guarantee data by automatically running an execution program when the user apparatus 120 receives the content. In addition, the content may have a function to discard the content after creating history information and guarantee data when manipulation to discard the content is performed on the user apparatus 120.

In a case where in response to receiving of content, history information and guarantee data are created by using an execution program provided along with a target file, another checking process separate from an initial checking process may be set up to check, in response to receiving of content, that the user apparatus 120 can communicate with the user-side node 220 in the blockchain system 200. Further, connectivity to the blockchain system 200 may be checked in the initial checking process performed when manipulation of the target file starts, and the creation of history information and guarantee data in response to receiving of the content may be performed after the initial checking process.

In the exemplary embodiment described above, the provider apparatus 110 provides content containing a target file and an execution program to the user apparatus 120 via the management server 130, which manages history information. In contrast, the provider apparatus 110 may provide content to the user apparatus 120 via a different server from the management server 130, or a network may directly connect the provider apparatus 110 and the user apparatus 120 so that content is directly provided.

In the exemplary embodiment described above, the provider apparatus 110 provides content containing a target file and an execution program to the user apparatus 120, and manipulation of a target file is monitored by using a function provided by the execution program. In contrast, an information processing apparatus configured to monitor manipulation of a target file may be provided to the user and used as the user apparatus 120. In such a case, a target file may separately be sent to an information processing apparatus provided to the user, or an information processing apparatus with a target file stored may be provided to the user. In the latter case, history information and guarantee data need not be created in response to receiving of content. Furthermore, various modifications and substitutions for the configuration that do not depart from the technical scope of the present disclosure are included in the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A non-transitory computer readable medium storing a program causing a computer to execute a process, the process comprising:
preparing a target file for manipulation, the target file being a file to be manipulated;
acquiring information regarding a situation in which the target file is manipulated;
based on the information that was acquired, in a case where a predetermined event occurs, creating history information and a hash value of the history information, the history information indicating occurrence of the predetermined event; and
associating the history information with the hash value and transmitting a transaction including the hash value to a blockchain network.

2. The non-transitory computer readable medium according to claim 1,
wherein the program causes the computer to execute the process, the process further comprising:
except by the preparing the target file for manipulation, preventing the target file from being prepared for manipulation.

3. The non-transitory computer readable medium according to claim 2,
wherein the program has an execution file combined with the target file.

4. The non-transitory computer readable medium according to claim 1,
wherein the program causes the computer to execute the process, the process further comprising:
when creating the history information and the hash value,
based on the information that was acquired, in response to detection of the target file being manipulated in a predetermined irregular situation, creating the history information and a hash value of the history information, the history information indicating occurrence of an irregular event.

5. The non-transitory computer readable medium according to claim 4,
wherein the program causes the computer to execute the process, the process further comprising:
in response to the detection of the target file being manipulated in the predetermined irregular situation, reporting occurrence of an irregular event in accordance with a type of irregularity that was detected.

6. The non-transitory computer readable medium according to claim 4,
wherein the program causes the computer to execute the process, the process further comprising:
in response to the detection of the target file being manipulated in the predetermined irregular situation, terminating manipulation of the target file in accordance with a type of irregularity that was detected.

7. The non-transitory computer readable medium according to claim 1,
wherein the program causes the computer to execute the process, the process further comprising:
checking whether an apparatus including the computer satisfies a predetermined set-up condition for manipulation of the target file; and
when preparing the target file for manipulation, allowing the target file to be prepared for manipulation in a case where the predetermined set-up condition is satisfied.

8. The non-transitory computer readable medium according to claim 7,
wherein the predetermined set-up condition includes capability of communicating with a specific external apparatus for the blockchain network.

9. The non-transitory computer readable medium according to claim 8,
wherein the program causes the computer to execute the process, the process further comprising:
based on the information that was acquired, in response to detection of the target file being manipulated in a predetermined irregular situation, reporting to the specific external apparatus on the target file being manipulated in the predetermined irregular situation.

10. The non-transitory computer readable medium according to claim 7,
wherein the program causes the computer to execute the process, the process further comprising:
before preparing the target file for manipulation, determining whether a situation in which the target file is manipulated is categorized as a predetermined situation; and
when preparing the target file for manipulation, allowing the target file to be prepared for manipulation in a case where the situation in which the target file is manipulated is categorized as the predetermined situation.

11. An information processing apparatus comprising:
a processor configured to:
prepare a target file for manipulation, the target file being a file to be manipulated;
acquire information regarding a situation in which the target file is manipulated;
based on the information, in a case where a predetermined event occurs, create history information and a hash value of the history information, the history information indicating occurrence of the predetermined event; and
store in a memory device the history information and the hash value in association with each other and transmit a transaction including the hash value to a blockchain network.

12. A method for information processing, the method comprising:
preparing a target file for manipulation, the target file being a file to be manipulated;
acquiring information regarding a situation in which the target file is manipulated;
based on the information that was acquired, in a case where a predetermined event occurs, creating history information and a hash value of the history information, the history information indicating occurrence of the predetermined event; and
associating the history information with the hash value and transmitting a transaction including the hash value to a blockchain network.
